(19) United States
(12) Patent Application Publication
(10) Pub. No.: US 2013/0046751 A1
(43) Pub. Date: Feb. 21, 2013

(54) Method and Arrangement for Control of Web Resources

(71) Applicants: Vlasios Tsiatsis, Solna (SE); Vincent Huang, Sollentuna (SE); Per-Olof Nerbrant, Osterskar (SE)

(72) Inventors: Vlasios Tsiatsis, Solna (SE); Vincent Huang, Sollentuna (SE); Per-Olof Nerbrant, Osterskar (SE)

(73) Assignee: TELEFONAKTIEBOLAGET L M ERICSSON (PUBL), Stockholm (SE)

(21) Appl. No.: 13/695,645

(22) PCT Filed: May 7, 2010
(86) PCT No.: PCT/SE2010/050506

§ 371 Date: Nov. 1, 2012

(51) Int. Cl. G06F 17/30

(52) U.S. Cl. 707/709; 707/736; 707/E17.108

(57) ABSTRACT

A method and arrangement in a server (300) for providing information about statements of a web resource (A) published on the internet by a first internet host and a second internet host. The server may be associated with an owner of the web resource. A registering module (300a) registers said statements and corresponding identifications of the first and second internet hosts. A storing module (300b) then stores registered statements and host identifications in a web resource usage record (R). When a receiving module (300c) receives a request (Rec) for information on the web resource, a delivery module (300d) delivers a response (Res) based on the stored statements and host identifications. The response indicates that the registered first and second internet hosts are logically linked by referring to the same web resource (A).

### TECHNICAL FIELD

The invention relates generally to a method and arrangement for providing information about statements of a web resource published by different internet hosts and accessible on the internet.

### BACKGROUND

In recent years, web searching by means of search engines has become very popular, i.e. using a communication network such as the Internet or “World Wide Web” when searching for information or content typically presented by internet hosts in web pages or the like. A terminal user can thus input one or more search terms or keywords in a search query to a search engine, which then executes a search for matches in files, web pages, etc., being maintained by the internet hosts at various servers or nodes connected to the network. Several well-known and quite powerful search engines and tools operating on the Internet are available today for web searching, e.g. Google and Yahoo.

Web pages are thus accessible on the Internet and typically contain information and statements regarding various entities and items, such as persons, products, articles, documents, enterprises, organisations, companies, events, locations, and practically anything that can be identified and described in text form. Such entities being referred to in web pages will be generally denoted “web resources” in the following description.

When a user submits keywords in a search query to a search engine, it mainly performs a lexicographical analysis to retrieve the web pages that contain one or more of the input keywords. If a search engine also attempts to find related web resources, then the engine typically uses text-based techniques, e.g. for finding web pages that contain the same text keywords or are mutually linked through explicit links in the text.

As the amount of information available on the Internet has grown into immense proportions, there is a great need to enable automatic and apt detection, analysis and processing of the logic presented in web pages, typically including statements of how different web resources relate to each other. Therefore, the concept of “semantic web technologies” has been developed for semantic annotation of different elements in web page statements, which can easily be identified and analysed by a “machine”, i.e. using software executed by a processor or computer. A technique called “Resource Description Framework” (RDF) has been developed as a language for representing various statements in web pages regarding web resources, by means of semantic annotation.

The content or text of a web page may include statements regarding relations between different web resources, and a statement can often be identified as having basically the form of a combination of “subject”, “predicate” and “object”. In such a statement, the subject identifies the entity or domain that the statement concerns, the predicate identifies a property or characteristic of the subject that the statement specifies, and the object identifies some “value” or range of that property. In other words, the predicate provides a relation between the subject and the object. One simple exemplary web page statement is: “Person X (subject) is a member (predicate) of Enterprise Z (object)”, where both Person X and Enterprise Z are web resources that are interrelated by the statement above.

In semantic web technologies according to the RDF, each element in such statements can be represented and annotated with an element identifier such as a URI (Unified Resource Identifier) in HTTP (HyperText Transfer Protocol) format. A statement can thus be logically represented by a triplet of element identifiers, URIs, such as (URI″X″, URI″Y″, URI″Z″). By representing different statements in a web page with such triplets of element identifiers, the content of the web page can be annotated in a machine-readable format to enable automatic analysis and processing of the information therein by means of software applications, in addition to just presenting the content visually to readers.

The semantic annotation of a web page can further be represented in the form of an ontology in an RDF graph, illustrating one or more statements regarding web resources, which will be explained by means of a simple example below. Generally, “ontology” is a branch of philosophy dealing with questions regarding what entities exist, and how entities can be described and related to each other in terms of properties, similarities and differences. Thus, a semantic website or web page basically represents the content in the website or web page in the form of an ontology. An RDF graph is built up by nodes, sometimes referred to as “vertices”, representing web resources, i.e. the subjects and objects, which are interconnected by arches, sometimes referred to as “edges”, representing some linking property or characteristic, i.e. the predicates. This type of information will be referred to as an “RDF-based ontology” comprising triplets of element identifiers.

The ontologies of two exemplary web pages 1 and 2 are shown as RDF graphs in FIG. 1. In this example, web page 1 is available from “Internet host 1” at http://www.website1.com and web page 2 is available from “Internet host 2” at http://www.website2.com. Web page 1 contains statements referring to four web resources A, B , C and D, while web page 2 contains statements referring to three web resources A, E and F.

In web page 1, resource A relates to resource B by the linking property or relation R1, and resource B relates to resource C by the linking property or relation R2 and further to resource D by the linking property or relation R3. Web page 1 thus basically contains three statements which can be annotated by triplets of element identifiers such as URIs as described above. The resources in web page 2 are mutually related as well in a similar manner, as illustrated in the figure.

Thus, each resource A-F and property or relation R1-R5 is annotated by a respective element identifier or URI, as further described above, in a “machine-readable” manner. Alternatively, a URL (Unified Resource Locator) or a URN (Unified Resource Name) can be used as HTTP format for the above annotation. For example, if resource A originates from a website www.website1.com, that resource may be annotated as “http://www.website1.com/this/is/resource/A” as the element identifier URI. The RDF graph of web page 1 can thus be described by the triplets (A,R1,B), (B,R2,C), and (B,R3,D).

In this example, it can be seen that resource A occurs in both web pages 1 and 2 as a joint resource which consequently forms a link logically connecting the two web pages and the internet hosts 1 and 2, as shown by the dashed two-way arrow, theoretically making the two internet hosts related to each other. Some web resources may occur at several different web pages and internet hosts thus providing a logical link between those web pages or internet hosts. Today, there is no practical means the creator or administrator of an internet host can find out which other internet hosts it is logically linked to in this way. Such linking information may actually be of interest for both the internet hosts and for parties associated with the resource. The linking information may also be useful for users to find and verify information about a resource occurring at the internet hosts/web pages.

Furthermore, a web searching computer program referred to as “web crawler” is often used, among other things, for browsing the Internet in an automated manner and for detecting links between internet hosts and web pages. Naturally, knowledge of the above linking information would facilitate the operation of web crawlers considerably.

In practice, a web resource may be used in multiple web pages usually beyond control. There is no convenient way to obtain knowledge of how and to what extent its resource occurs in different web pages and internet hosts. In particular, it may not be possible to control or certify the various statements that are published in the web pages, e.g. with respect to truthfulness or relevance. For example, a statement regarding a resource in a web page may be downright false or otherwise unsuitable, violating or offending to parties associated with the resource. It is further not possible to prevent certain statements regarding a web resource from being published at particular internet hosts, or parties associated with the resource may not want to be associated with a certain internet host or website whatsoever.

### SUMMARY

It is an object of the invention to address at least some of the problems and issues outlined above. It is also an object to enable a requesting party to find out how web resources occur in web pages and how information about the web resources can be accessed in a communication network. It is possible to achieve these objects and others by using a method and an arrangement as defined in the attached independent claims.

According to one aspect, a method is provided in a server to deliver information about statements of a web resource that are published on the internet by a first internet host and a second internet host. In this method, the above statements and corresponding identifications of the first and second internet hosts are registered by the server and stored in a web resource usage record in the server. When the server receives a request for information on the web resource from a requesting party, a response to the request is delivered based on the stored statements and host identifications. The response indicates that the first and second internet hosts are logically linked by publishing the statements of the web resource.

According to another aspect, an arrangement is provided that is configured to deliver information about statements of a web resource that are published on the internet by a first internet host and a second internet host. According to this arrangement, the server comprises a registering module adapted to register the statements and corresponding identifications of the first and second internet hosts, and a storing module adapted to store the statements and identifications of the first and second internet hosts in a web resource usage record. The server also comprises a receiving module adapted to receive a request for information on the web resource, and a delivery module adapted to deliver a response to the request based on the stored statements and host identifications.

In this way, the requesting party will be able to obtain knowledge of how and where the web resource is referred to in statements published by different internet hosts. The resource owner is also able to check and verify the truthfulness and/or relevance of the statements.

The above method and arrangement may be configured and implemented according to different embodiments as described in the detailed description below.

### BRIEF DESCRIPTION OF DRAWINGS

The invention will now be described in more detail by means of exemplary embodiments and with reference to the accompanying drawings, in which:

FIG. 1 is a schematic diagram illustrating exemplary RDF graphs for two web pages, according to the prior art.

FIG. 2 is a flow chart with steps performed by a server, according to an exemplary embodiment.

FIG. 3 is a block diagram illustrating a server in more detail when in operation, according to further exemplary embodiments.

FIG. 4 is a schematic diagram illustrating an example of how the server can maintain registration information in practice, according to another possible embodiment.

### DETAILED DESCRIPTION

Briefly described, a solution is provided for obtaining information and control of how web resources occur in statements published by internet hosts in web pages accessible over the Internet. In this solution, it has been recognised that some web resources can be associated to an owner basically entitled to control the resources, which can be referred to as “specific” resources, while other web resources may not have a natural owner in that sense, i.e. more “generic” resources. For example, a person is naturally the owner of his/her specific identity, and a particular product, company or organisation could likewise have a rightful owner. Other web resources such as locations, events, articles and documents may or may not have an owner.

In this description, it is assumed that a web resource can have a rightful or relevant owner in some sense, which is not further elaborated here, and only web resources having an owner will be discussed in the following in a technical context, basically. A web resource owner is thus generally defined here as a party entitled to control the web resource. For example, the web resource owner party may be one or more persons, an organisation or a company. Further, a web resource can also be considered as an “information subject” or the like that may originate at a website, and different websites, or rather their creators, can effectively be web resource owners as well.

In this solution, a registration procedure is introduced where statements of a particular web resource published by internet hosts in web pages or the like at websites, are registered at a server which may, without limitation, preferably be associated with the owner of the web resource. In this description, “using” a web resource by an internet host indicates that the web resource occurs in a statement published by that internet host. Supervision of the web resource statements can be enabled by registering, in the server, the statements of the web resource and the internet hosts that publish the statements, and by storing the statements and identities of corresponding internet hosts in a web resource usage record at the server. Whenever the server receives a request for information on the web resource, a response is delivered based on the stored statements and host identities, which thus indicates that the registered internet hosts are logically linked by using the same web resource.

Information regarding the statements of the web resource may further be registered in the form of an RDF-based ontology comprising triplets of element identifiers, where each triplet represents a statement of the web resource. It is thus possible to utilise the above-described semantic web technologies to describe the web resource statements in a machine-readable manner, e.g. in the web resource usage record and when responding to information requests.

In this way, a requesting party will be able to obtain knowledge of how and where the web resource is referred to in statements published by different internet hosts, from a single point of collected information, i.e., the server described herein. The web resource owner will also be able to supervise how the web resource is described in the statements by the internet hosts. In particular, the resource owner can easily check and verify any statements that are made in web pages regarding the web resource, e.g. with respect to truthfulness or relevance.

Statements published by internet hosts that have been registered and verified in this way will also be deemed more reliable for a requesting party or any party that visits those internet hosts, e.g. by marking the statements in the web pages or in the request response above as verified or the like. This solution further enables the web resource owner to discover and evaluate a certain statement regarding its web resource made by a particular internet host. Should the resource owner find the statement to be false, irrelevant, offending or unsuitable, or do not want to be associated with the internet host whatsoever, he/she may contact that internet host or take other actions, however being outside the scope of this solution.

It is further possible to infer new knowledge regarding the web resource and other linked web resources from the registered web resource statements above, e.g. by creating an aggregated RDF-based ontology with collected statements on the web resource. The aggregated RDF ontology can be created from a plurality of RDF ontologies valid for respective internet hosts that refer to the web resource, e.g. in web pages. New information relating to implied new relationships and logical links between web resources may thus be inferred based on the aggregated RDF ontology. The solution will be further described and explained by the following exemplary embodiments and referring to the drawings.

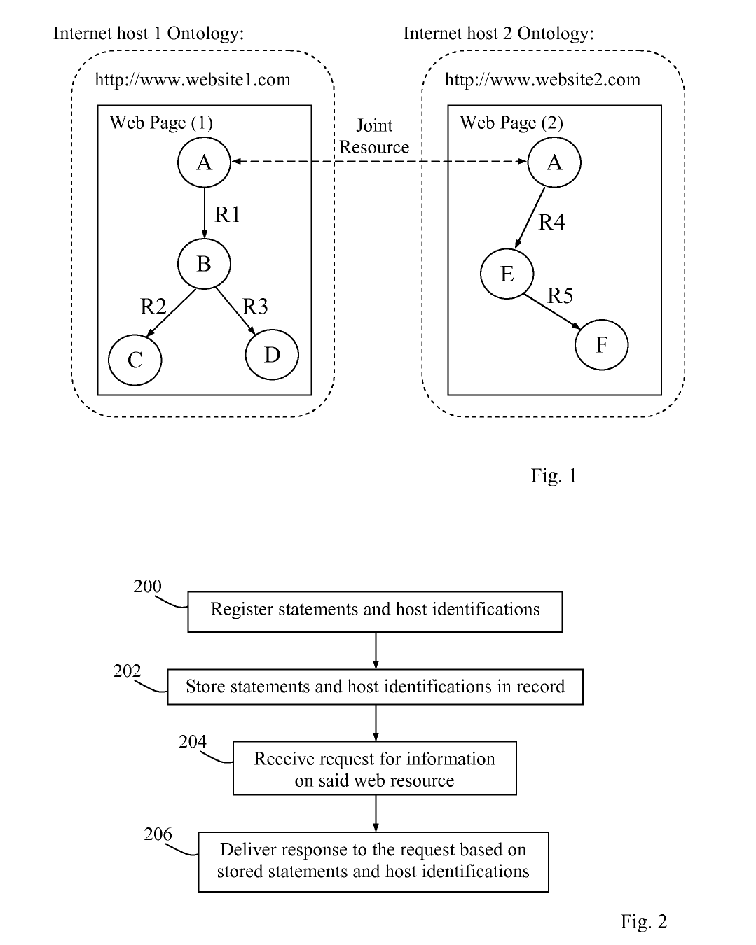

A procedure for providing information about statements of a web resource published on the internet by internet hosts, will now be described with reference to FIG. 2, which is performed by a server that may preferably be associated with an owner of the web resource although the invention is not limited in this respect. In a first action 200, the server registers statements of the web resource published by a first and a second internet host, and also registers corresponding identifications of the first and second internet hosts. In this context, it can thus be deduced that the internet hosts that refer to this web resource are deemed to be logically linked by using the same web resource.

The web resource usage may be registered in different ways. For example, at least one of the first and second internet hosts may be registered when a registration request for a statement of the web resource is received from that internet host. Alternatively, at least one internet host can be registered by using a web crawler capable of detecting a statement of the web resource at that internet host. Web crawlers are known per se and are not necessary to be described in detail here to understand this invention. The web crawler may be provided either at the server or by an external third party service that maintains information on which internet hosts that use or refer to different web resources, including the web resource above.

The server then stores the statements and identifications of the first and second internet hosts in a web resource usage record in a next action 202. The web resource usage record thus contains identities of the internet hosts and also information on the statements being published by the respective internet hosts regarding the web resource e.g. in web pages. As mentioned above, the statements involving the web resource can be described in an RDF ontology with triplets of element identifiers according to the semantic web technologies. The web resource usage record may be implemented as a list of internet hosts that refer to the owned web resource, optionally with additional triplets of element identifiers representing the different statements of the web resource.

At some point later, the server receives a request for information on the web resource from a requesting party, in a further action 204. The requesting party may be any person or entity that might be interested in what has been said or stated by the internet hosts, e.g. in web pages, regarding the web resource. For example, the web resource owner may submit the request in order to check and verify any statements regarding the web resource, e.g. as discussed above. The web resource owner may wish to prevent a certain statement from being published at a particular internet host or website, which is however somewhat outside the scope of the solution described here. A web crawler may also submit the request in order to detect logical links between different internet hosts or web pages, which would facilitate its operation when browsing the Internet.

In a final shown action 206, the server delivers a suitable response to the request above, based on the stored statements and host identifications. In particular, the response basically indicates that the first and second internet hosts are deemed to be logically linked by publishing statements of the same web resource.

As indicated above, information regarding the statements of the web resource can be registered and included in the web resource usage record as RDF-based ontologies with triplets of element identifiers representing the statements regarding the web resource. In that case, an RDF ontology with one or more statements of the web resource may be received in a registration request from an internet host. Alternatively, when a statement of the web resource is detected by means of a web crawler residing either in the server or in a third party service, an RDF ontology may be determined by means of that web crawler.

The element identifiers in the RDF ontology can be annotated in a HTTP format as a URI, URL or URN. The RDF ontology may further be determined or updated at some point after the statement of the web resource has been registered. For example, a URI of a web resource may be a HTTP URI that can be used as an accessible URL. Thereby, the server's network own address may also include the URL, i.e. the resource URI, and the server can thus easily be controlled by the resource owner. One advantage of doing this is that no other lookup or indexing system is required since the information about the resource can be accessed simply by means of the resource's name.

Furthermore, an aggregated RDF-based ontology with collected statements on the web resource may also be created from a plurality of RDF-based ontologies representing statements by respective internet hosts that use or refer to the web resource, e.g. in web pages. In that case, information on implied new relationships between web resources can be inferred, based on the aggregated RDF ontology. The web resource usage record may be maintained at the server as a data structure, e.g. in the URI format, which is at least partly included in the response of action 206. It is thus possible to “hide” certain parts of the aggregated RDF ontology, if desired, in the response.

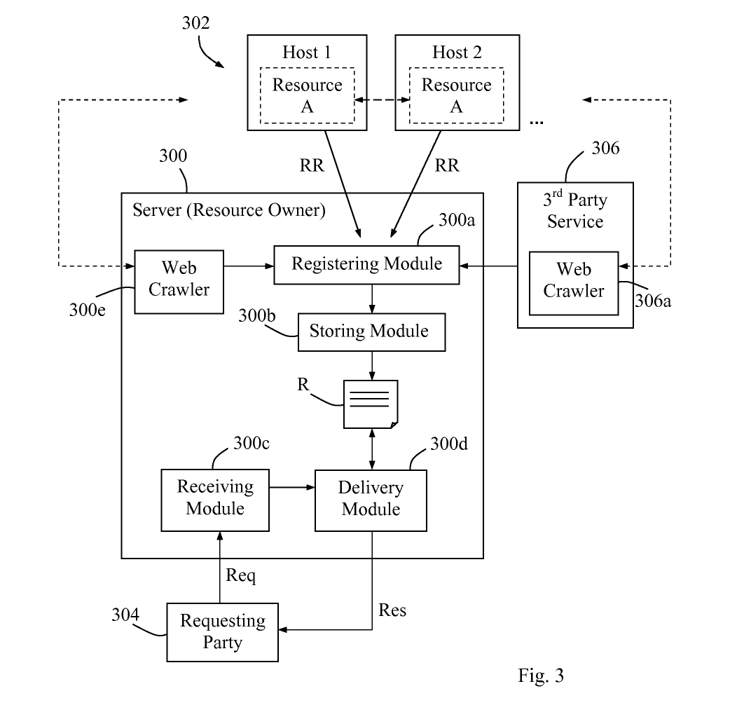

In FIG. 3, an arrangement in a server 300 is illustrated when in operation according to this solution to provide information about statements of a web resource A. The server may be associated with the web resource owner while it could be operated and controlled by any suitable party. The web resource A is thus involved in statements published by a first and a second internet host 302, although it can be understood that this solution is applicable for any number of internet hosts. Thereby, internet hosts 1 and 2 are logically linked, as schematically indicated by the dashed two-way arrow, by the fact that they both refer to the same web resource A in one or more statements published and available by the respective internet hosts.

According to this arrangement, the server 300 comprises a registering module 300a adapted to register the statements and corresponding identifications of the first and second internet hosts 302. The owner of web resource A may of course also be the owner of further web resources, not discussed here, which could likewise be registered and handled by server 300 in the manner described.

Server 300 further comprises a storing module 300b adapted to store the statements and identifications of the first and second internet hosts 302 in a web resource usage record R, basically as described for action 202 above. As indicated in the figure, a host 302 may be registered for publishing a statement of the web resource when a registration request “RR” for usage of the web resource by that internet host is received. Otherwise, an internet host may be registered when a web crawler detects a statement of the web resource at that internet host. This may be done by means of a web crawler 300e associated with the server 300, or by means of a web crawler 306a belonging to an external third party service 306 that generally maintains information on which internet hosts that use or refer to different web resources, including web resource A.

Server 300 further comprises a receiving module 300c adapted to receive a request “Req” for information on web resource A from a requesting party 304, e.g. the actual owner of web resource A, a web crawler, or any other party interested in what information and statements have been published for web resource A by various internet hosts.

Server 300 further comprises a delivery module 300d adapted to deliver a response “Res” to the requesting party 304, based on the stored statements and host identifications in the web resource usage record R. The response effectively indicates that the registered internet hosts 302 are logically linked by referring to the same web resource A. The response could further contain more detailed information on what statements have been made by the internet hosts 302, as described above, e.g. in the form an aggregated RDF ontology created from a plurality of RDF ontologies representing respective statements published by the internet hosts 302.

The RDF ontologies of internet hosts 302 as well as the aggregated RDF ontology, if used, may be maintained in the web resource usage record R. The delivered response Res may contain information from one or more of the RDF ontologies of websites 302 or from an aggregated RDF ontology, either the complete ontology or only a part of thereof e.g. if other parts are made unavailable, or invisible, by the web resource owner. In this solution, it is thus possible for the web resource owner to selectively control what parts of the collected information on the statements of the web resource should be made available to requesting parties. The availability of registered web resource statements from the server 300 may further be selective depending on the identity of the requesting party.

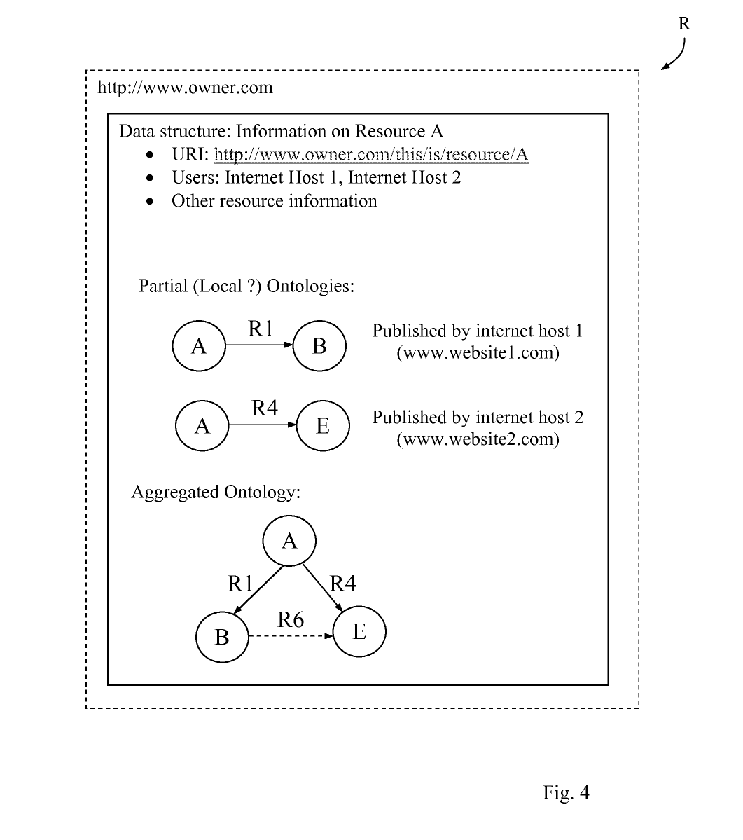

It should be noted that FIG. 3 merely illustrates various functional modules or units in the server 300 in a logical sense, although the skilled person is free to implement these functions in practice using suitable software and hardware means. Thus, the invention is generally not limited to the shown structures of the server 300, while its functional modules 300a-e may be configured to operate according to the methods and procedures described for FIGS. 1 and 2 above and for FIG. 4 below, where appropriate.

For example, the registering module 300a may be further adapted to register information regarding the statements of the web resource in the form of an RDF-based ontology comprising triplets of element identifiers, each triplet representing a statement of the web resource. The registering module 300a may be further adapted to obtain the RDF-based ontology from the registration request RR or by means of the web crawler 300e or 306a. The storing module 300b may be further adapted to determine or update the RDF-based ontology e.g. after registering the at least one internet host 302.

In further examples, the storing module 300b may be adapted to create an aggregated RDF-based ontology with collected statements of the web resource from a plurality of RDF-based ontologies representing statements by respective internet hosts 302 that refer to the web resource. The storing module 300b may also be adapted to infer information on implied new relationships between web resources, based on the aggregated RDF-based ontology.

The storing module 300b may further be adapted to annotate the element identifiers in the RDF-based ontology in a HTTP format selected from: URI, URL and URN. The registering module 300a may also be adapted to register at least one of the first and second internet hosts 302 when a registration request RR for a statement of the web resource is received from the at least one internet host.

The registering module 300a may further be adapted to register at least one of the first and second internet hosts 302 when web crawler 300e or 306a detects a statement of the web resource by the at least one internet host. Still further, the storing module 300b may be adapted to maintain the web resource usage record R at the server 300 as a data structure in the URI format which the delivery module 300d includes at least partly in the response Res.

The functional modules 300a-e described above can be implemented as program modules of a computer program comprising code means which when run by a processor in the server 300 causes the server to perform the above-described functions and actions. The computer program may be carried by a computer program product comprising a computer readable medium on which the computer program is stored. For example, the computer program product may be a flash memory, ROM (Read-Only Memory) or an EEPROM (Electrically Erasable Programmable ROM), and the computer program modules described above could in alternative embodiments be distributed on different computer program products in the form of memories within the server 300.

An example of how the server 300 in FIG. 3 can maintain registration information for web resource A in the web resource usage record R in practice, will now be described with reference to FIG. 4. In this example, the record R is maintained in the server 300 by an internet host associated to the web resource owner, which can be accessed from http://www.ownercom and having a data structure with information on web resource A collected by means of the above-described registration procedure. This data structure may be in the URI format, although the invention is not limited thereto. Similar web resource usage records may be maintained in server 300 for other web resources and web resource owners, and the invention is not limited in this respect either.

In the example in FIG. 4, it is assumed that two internet hosts 1 and 2 have published statements according to the RDF ontologies shown in FIG. 1, thus at least partly involving web resource A. The information on web resource A in the data structure includes a URI that has been defined to identify resource A itself: “http://www.owner.com/this/is/resource/A”. The data structure further includes identities of internet hosts 1 and 2 referring to resource A, e.g. in the form of web addresses or similar, and possibly also other resource information, e.g. various characteristics or features of resource A.

The data structure further includes RDF ontologies obtained for internet hosts 1 and 2 during or after the registration procedure, thus representing published statements involving resource A, in the form of triplets of element identifiers, which may be denoted “partial” or “local” RDF ontologies. Thus, the partial/local ontology obtained for internet host 1 contains the triplet (A,R1,B), while the partial/local ontology of internet host 2 contains the triplet (A,R4,E). From these partial/local RDF ontologies, an aggregated RDF ontology can be created with both triplets (A,R1,B) and (A,R4,E), as shown in the figure, thus representing the collected statements on the web resource A.

It is also possible to infer information on implied new relationships between different web resources, based on the created aggregated RDF ontology. In this example, a new relation or link “R6” between web resources B and E has been inferred, as implied by the two partial/local RDF ontologies of hosts 1 and 2, as indicated by the dashed arrow in the aggregated RDF ontology. Depending on the logic of the collected statements on resource A in the aggregated RDF ontology, it may further be possible to derive new information therefrom regarding resource A itself, which could be expressed as a new statement represented by a new triplet of element identifiers, which is however outside the scope of this solution.

While the invention has been described with reference to specific exemplary embodiments, the description is generally only intended to illustrate the inventive concept and should not be taken as limiting the scope of the invention. The invention is defined by the appended claims.

1-25. (canceled)

26. A method, in a server, for providing information about statements of a web resource that are published on the Internet by a first Internet host and a second Internet host, the method comprising:
registering, in the server, the statements and corresponding identifications of the first and second Internet hosts;
storing the statements and identifications of the first and second Internet hosts in a web resource usage record;
receiving a request for information about the web resource; and
delivering a response to the request based on the stored statements and host identifications, the response indicating that the first and second Internet hosts are logically linked by each host having published statements about the same web resource.

27. The method of claim 26, further comprising registering information regarding the statements of the web resource in the form of a Resource Description Framework (RDF) based ontology comprising triplets of element identifiers, each triplet representing a statement of the web resource.

28. The method of claim 27, further comprising creating an aggregated RDF-based ontology with collected statements of the web resource from a plurality of RDF-based ontologies representing statements by respective Internet hosts that refer to the web resource.

29. The method of claim 28, further comprising inferring information about implied new relationships between web resources based on the aggregated RDF-based ontology.

30. The method of claim 27, wherein the element identifiers in the RDF-based ontology are annotated in a HypertText Transfer Protocol (HTTP) format selected from:
a Unified Resource Identifier (URI);
a Unified Resource Locator (URL); and
a Unified Resource Name (URN).

31. The method of claim 27, wherein the RDF-based ontology is obtained from a registration request.

32. The method of claim 27, wherein the RDF-based ontology is determined or updated after registering the first and second Internet host.

33. The method of claim 27, wherein the RDF-based ontology is determined at least partly by a web crawler.

34. The method of claim 26, wherein the registering comprises registering at least one of the first and second Internet hosts when a registration request for a statement of the web resource is received from the at least one Internet host.

35. The method of claim 26, wherein the web resource usage record is maintained at the server as a data structure in the Uniform Resource Identifier (URI) format, the data structure being at least partly included in the response.

36. The method of claim 26, wherein the registering comprises registering at least one of the first and second Internet hosts when a web crawler detects a statement of the web resource by the at least one Internet host.

37. The method of claim 36, wherein the web crawler is associated with the server.

38. The method of claim 36, wherein the web crawler belongs to a third party service that maintains information about which Internet hosts refer to the web resource.

39. A server configured to provide information about statements of a web resource that are published on the Internet by a first Internet host and a second Internet host, the server comprising:
a registering module configured to register the statements and corresponding identifications of the first and second Internet hosts;
a storing module configured to store the statements and identifications of the first and second Internet hosts in a web resource usage record;
a receiving module configured to receive a request for information about the web resource; and
a delivery module configured to deliver a response to the request based on the stored statements and host identifications, the response indicating that the first and second internet hosts are logically linked by each host having published statements about the same web resource.

40. The server of claim 39, wherein the registering module is further configured to register information regarding the statements of the web resource in the form of a Resource Description Framework (RDF) based ontology comprising triplets of element identifiers, each triplet representing a statement of the web resource.

41. The server of claim 40, wherein the registering module is further configured to obtain the RDF-based ontology from the registration request.

42. The server of claim 40, wherein the storing module is further configured to determine or update the RDF-based ontology after registering the first and second Internet host.

43. The server of claim 40, wherein the storing module is further adapted to determine the RDF-based ontology at least partly from a web crawler.

44. The server of claim 40, wherein the storing module is further adapted to annotate the element identifiers in the RDF-based ontology in a HypertText Transfer Protocol (HTTP) format selected from:
a Unified Resource Identifier (URI);
a Unified Resource Locator (URL); and
a Unified Resource Name (URN).

45. The server of claim 40, wherein the storing module is further configured to create an aggregated RDF-based ontology with collected statements of the web resource from a plurality of RDF-based ontologies representing statements by respective Internet hosts that refer to the web resource.

46. The server of claim 45, wherein the storing module is further configured to infer information about implied new relationships between web resources based on the aggregated RDF-based ontology.

47. The server of claim 39, wherein the registering module is further configured to register at least one of the first and second Internet hosts when a registration request for a statement of the web resource is received from the at least one Internet host.

48. The server of claim 39:
wherein the storing module is further configured to maintain the web resource usage record at the server as a data structure in Unified Resource Identifier (URI) format;
wherein the delivery module is further configured to include the data structure at least partly in the response.

49. The server of claim 39, wherein the registering module is further configured to register at least one of the first and second Internet hosts when a web crawler detects a statement of the web resource by the at least one Internet host.

50. The server of claim 49, wherein the web crawler is associated with the server.
